(19) United States
(12) Patent Application Publication
(10) Pub. No.: US 2025/0384677 A1
(43) Pub. Date: Dec. 18, 2025

(54) METHOD AND APPARATUS FOR OBJECT DETECTION THAT CAN SELECTIVELY REFLECT EXPRESSION INFORMATION OF LARGE LANGUAGE MODEL

(71) Applicant: Korea Electronics Technology Institute, Seongnam-si (KR)

(72) Inventors: Choong Sang CHO, Seongnam-si (KR); Young Han LEE, Seongnam-si (KR); Ju Hong YOON, Hwaseong-si (KR); Gui Sik KIM, Seongnam-si (KR); Tae Woo KIM, Seongnam-si (KR)

(73) Assignee: Korea Electronics Technology Institute, Seongnam-si (KR)

(21) Appl. No.: 18/897,692

(22) Filed: Sep. 26, 2024

(30) Foreign Application Priority Data
Jun. 14, 2024 (KR) 10-2024-0077451

(51) Int. Cl. G06V 10/82; G06V 10/77; G06V 10/778; G06V 10/80

(52) U.S. Cl. CPC G06V 10/82; G06V 10/7715; G06V 10/7788; G06V 10/806

(57) ABSTRACT

There are provided a method and an apparatus for object detection. An object detection method according to an embodiment includes: acquiring, by an object detection system, image information including correct answer information on objects, and additional information on objects which is extracted through a generalization intelligence model; training, by the object detection system, an object detection engine based on the acquired information; and performing, by the object detection system, object detection by using the trained object detection engine, and performing the object detection includes selectively determining whether to reflect the additional information in the process of performing the object detection according to whether the additional information on the objects is acquired.

### CROSS-REFERENCE TO RELATED APPLICATION(S) AND CLAIM OF PRIORITY

This application is based on and claims priority under 35 U.S.C. § 119 to Korean Patent Application No. 10-2024-0077451, filed on Jun. 14, 2024, in the Korean Intellectual Property Office, the disclosure of which is herein incorporated by reference in its entirety.

### BACKGROUND

### Field

The disclosure relates to a method and an apparatus for object detection, and more particularly, to a method and an apparatus for object detection, which can perform object detection by reflecting expression information (vector information) of a generalization intelligence model such as a large language model (LLM) along with visual information (image).

### Description of Related Art

Object detection, which determine types and locations of objects in images by using artificial intelligence (AI) models, are being actively studied.

Related-art object detection techniques may use a structure that considers visual information (image) inputted to learn object detection along with correct answer information on objects included in the corresponding image.

However, these related-art object detection techniques only use given image information to find types and locations (bounding box) of included objects, and thus have limitations that additional information is not available.

### SUMMARY

The disclosure has been developed in order to solve the above-described problems, and an object of the disclosure is to provide a method and an apparatus for object detection, which can perform object detection by reflecting expression information (vector information) of a generalization intelligence model such as an LLM along with visual information (image).

Another object of the disclosure is to provide a method and an apparatus for object detection, which can perform object detection only with a given image when vector information (additional information) on objects is not available.

According to an embodiment of the disclosure to achieve the above-described object, an object detection method may include: acquiring, by an object detection system, image information including correct answer information on objects, and additional information on objects which is extracted through a generalization intelligence model; training, by the object detection system, an object detection engine based on the acquired information; and performing, by the object detection system, object detection by using the trained object detection engine, and performing the object detection may include selectively determining whether to reflect the additional information in the process of performing the object detection according to whether the additional information on the objects is acquired.

The generalization intelligence model may include a vector information extraction module configured to apply a prompt in which an explanation on each object is written and to extract vector information from a plurality of hidden layers.

The additional information on the objects may be comprised of a pair of vector information on each type of object.

Performing the object detection may include, when it is determined that the additional information on the objects is reflected, performing the object detection by reflecting the additional information including the vector information on each type of object, based on the correct answer information included in the image information, and, when the object detection is performed based on only the image information, using a zero vector to indicate the non-use of the additional information.

Performing the object detection may include using the additional information of the generalization intelligence model if a random probability (p) is less than or equal to a predetermined reference probability (p0), and using the zero vector if the random probability (p) is greater than the predetermined reference probability (p0).

In addition, performing the object detection may include, when the additional information of the generalization intelligence model is used, using additional information on some objects if the random probability (p) is less than or equal to a first probability (P1) which is set for some objects of the entire objects included in the image information, and using additional information on the entire objects if the random probability (p) is greater than the first probability (P1), and the additional information on some objects or the additional information on the entire objects may include a mean value or an accumulated value of vector information of each object on some objects or the entire objects.

When an object type list included in the additional information is provided, the object detection system may configure a vector including a mean value or an accumulated value of vector information of each object corresponding to the object type list based on the additional information.

The object detection system may include an information providing projection module provided to transform vector information of each type of object included in the additional information to merge with an image feature extraction result when the additional information of the generalization intelligence model is used, and the information providing projection module may be implemented by a projection multi-layer perceptron (MLP) structure, and a bias of a convolution layer provided in the information providing projection module may be set to a false, such that, if all values of input vectors are zero, all values of output vectors are zero.

The object detection system may further include an image feature extraction module configured to extract features from the image information, and performing the object detection may include performing the object detection by performing a vector element-by-element sum operation on the vector information transformed through the information providing projection module with respect to an output result of the image feature extraction module, and then applying a result of the sum operation as an input to the object detection engine.

According to another embodiment of the disclosure, an object detection system may include: an input unit configured to acquire image information including correct answer information on objects, and additional information on objects which is extracted through a generalization intelligence model; and a processor configured to train an object detection engine based on the acquired information, and to perform object detection by using the trained object detection engine, and the processor may selectively determine whether to reflect the additional information in the process of performing the object detection according to whether the additional information on the objects is acquired.

According to still another embodiment of the disclosure, an object detection method may include: training, by an object detection system, an object detection engine based on image information including correct answer information on objects and additional information on objects which is extracted through a generalization intelligence model; and performing, by the object detection system, object detection by using the trained object detection engine, and performing the object detection may include selectively determining whether to reflect the additional information in the process of performing the object detection according to whether the additional information on the objects is acquired.

According to embodiments of the disclosure as described above, when information on an object class included in an image is acquired at an object detection inference step, the information may be applied to an object detection engine inference step, so that performance is enhanced.

When additional information on objects included in the image is not provided at the object detection inference step, objection detection inference is enabled only with the given image and performance of the object detection engine is enhanced, and the object detection engine may be used in various object detection application services.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view provided to explain an object detection apparatus according to an embodiment of the disclosure;

FIG. 2 is a flowchart provided to explain an object detection method according to an embodiment of the disclosure;

FIG. 3 is a view provided to explain a process of training an object detection engine according to an embodiment of the disclosure;

FIG. 4 is a view provided to explain a generalization intelligence model applied to the object detection apparatus according to an embodiment of the disclosure;

FIG. 5 is a view provided to explain an object detection process of the object detection apparatus according to an embodiment of the disclosure;

FIG. 6 is a view provided to explain a process of the object detection apparatus selectively determining whether to reflect additional information of the generalization intelligence model according to an embodiment of the disclosure; and

FIG. 7 is a view provided to explain a process of the object detection apparatus selectively determining whether to reflect additional information of the generalization intelligence model according to an embodiment of the disclosure.

### DETAILED DESCRIPTION

Hereinafter, the disclosure will be described in more detail with reference to the accompanying drawings.

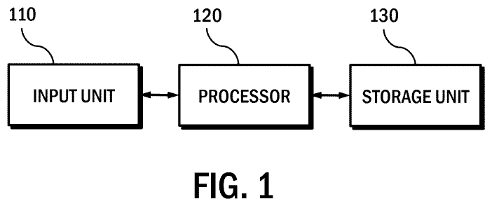

FIG. 1 is a view provided to explain an object detection apparatus according to an embodiment of the disclosure.

The object detection apparatus according to an embodiment may perform object detection by reflecting expression information (vector information) of a generalization intelligence model 10 along with visual information (image), and may perform object detection only with a given image even when vector information (additional information) on objects is not available.

To achieve this, the object detection apparatus may include an input unit 110, a storage unit 130, and a processor 120.

The input unit 110 is provided to acquire data necessary for object detection.

For example, the input unit 110 may acquire image information including correct answer information on objects and additional information on objects which is extracted through the generalization intelligence model 10.

Here, the generalization intelligence model 10 may be a generative AI model like a large language model (LLM).

The storage unit 130 is a storage medium that stores programs and data necessary for operations of the processor 120.

For example, the storage unit 130 may store data that is acquired through a trained object detection engine and the input unit 110.

The processor 120 may train the object detection engine based on information acquired through the input unit 110 by interworking with the generalization intelligence model 10, and may perform object detection by using the trained object detection engine.

Specifically, the processor 120 may selectively determine whether to reflect additional information according to whether additional information on objects is acquired in the process of detecting objects.

That is, when additional information on objects is acquired, the processor 120 may perform object detection by reflecting the additional information on the objects along with image information, and, when additional information is not available, the processor 120 may perform object detection by reflecting only image information.

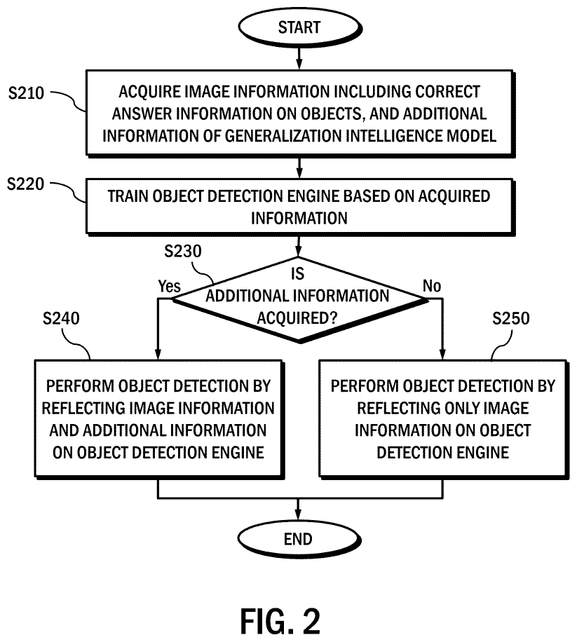

FIG. 2 is a flowchart provided to explain an object detection method according to an embodiment of the disclosure.

The object detection method according to an embodiment may be performed by the object detection system described above with reference to FIG. 1.

Specifically, when image information including correct answer information on objects and additional information on objects which is extracted through the generalization intelligence model 10 are acquired (S210), the object detection system may train the object detection engine based on the acquired information (S220), and may perform object detection by using the trained object detection engine.

In this case, the object detection system may selectively determine whether to reflect additional information according to whether the additional information on objects is acquired in the process of detecting objects.

Specifically, when additional information on objects is acquired (S230—Yes), the object detection system may perform object detection by reflecting the additional information on the objects and image information (S240), and, when the additional information on the objects is not acquired (S230—No), the object detection system may perform object detection by reflecting only the image information (S250).

For example, when it is determined that additional information on objects is reflected, the object detection system may perform object detection by reflecting the additional information which includes vector information of each type of object, based on correct answer information included in the image information, and, when object detection is performed based on only the image information, the object detection system may use a zero vector to indicate the non-use of additional information.

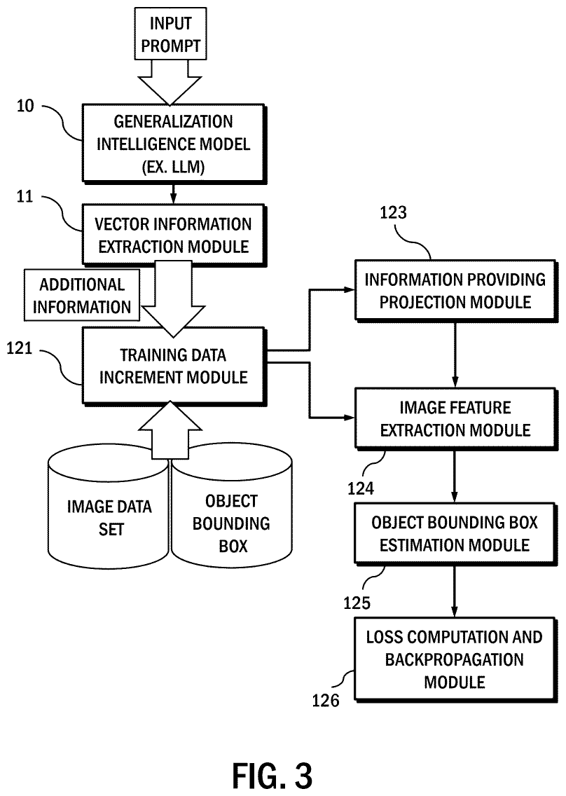

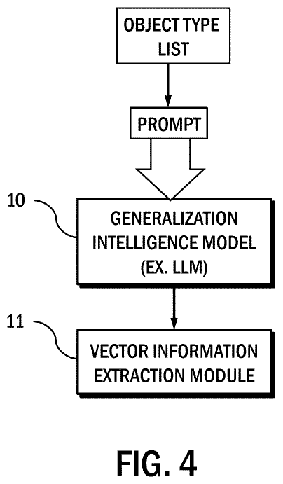

FIG. 3 is a view provided to explain a process of training the object detection engine according to an embodiment of the disclosure, and FIG. 4 is a view provided to explain the generalization intelligence model 10 applied to the object detection apparatus according to an embodiment of the disclosure.

The object detection system may acquire additional information on objects which is extracted through the generalization intelligence model 10 by interworking the generalization intelligence model 10, and may train the object detection engine by reflecting the additional information with image information.

Here, the generalization intelligence model 10 may apply a prompt having an explanation on each object written therein, and may include a vector information extraction module 11 which extracts vector information from a plurality of hidden layers.

That is, a user may configure a prompt on an explanation about an object and a using method thereof, based on a list corresponding object detection, and may input the prompt to the generalization intelligence model 10, and may extract vector information (vi) from a hidden layer of the generalization intelligence model 10 which is comprised of a plurality of layers (N layers). In this case, the vectors outputted from the plurality of layers (N layers) may be used as a mean value or an accumulated value according to utilization by the user as shown in the following equations:

$$\frac{1}{N} {\sum }_{i = 1}^{N} {v}_{i} … Equation for a mean value$$

$${\sum }_{i = 1}^{N} {v}_{i} … Equation for an accumulated value$$

Additional information on objects which is extracted through the generalization intelligence model 10 may be comprised of a pair of vector information for each type of object.

The object detection system may include a training data increment module 121 provided to train the object detection engine based on information acquired through the input unit 110 by interworking with the generalization intelligence model 10, an image feature extraction module 124 provided to perform object detection by using the trained object detection engine, an object bounding box estimation module 125, and a loss calculation and backpropagation module 126.

In addition, the object detection system may further include an information computation module 122 which computes to selectively determine whether to reflect additional information according to the additional information on objects is acquired, and an information providing projection module 123 which transforms additional information on objects to merge with a result of the image feature extraction module 124 according to a result of determining by the information computation module 122.

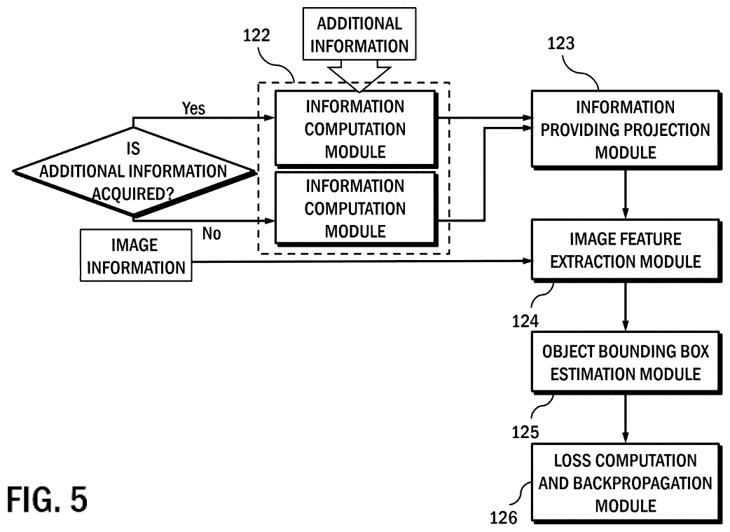

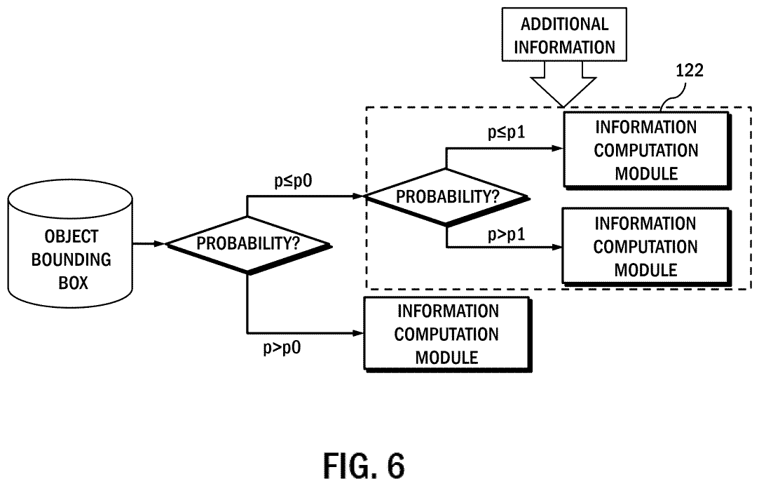

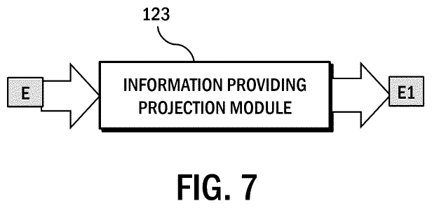

FIG. 5 is a view provided to explain the object detection process of the object detection apparatus according to an embodiment of the disclosure, FIG. 6 is a view provided to explain a process of the object detection apparatus selectively determining whether to reflect additional information of the generalization intelligence model 10 according to an embodiment of the disclosure, and FIG. 7 is a view provided to explain the process of the object detection apparatus selectively determining whether to reflect additional information of the generalization intelligence model 10 in detail according to an embodiment of the disclosure.

The training data increment module 121 may train the object detection engine to use additional information of the generalization intelligence model if a random probability (p) is less than or equal to a predetermined reference probability (p0), and to use a zero vector “V=zeros( )” indicating the non-use of additional information of the generalization intelligence model 10 if the random probability (p) is greater than the predetermined reference probability (p0).

The information computation module 122 may perform computation to selectively determine whether to reflect additional information according to whether the additional information on objects is acquired.

For example, the information computation module 122 may determine to use additional information of the generalization intelligence model 10 if the random probability (p) is less than or equal to the predetermined reference probability (p0), and may determine to use a zero vector indicating the non-use of additional information of the generalization intelligence model 10 if the random probability (p) is greater than the predetermined reference probability (p0).

Here, when additional information of the generalization intelligence model 10 is used, the information computation module 122 may determine to use additional information on some objects if the random probability (p) is less than or equal to a first probability (P1) set for some of the entire objects included in image information, and may determine to use additional information on the entire objects when the random probability (p) is greater than the first probability (P1).

The additional information on some objects or the additional information on the entire objects may include a mean value or an accumulated value of vector information on each object for some objects or the entire objects.

Here, some objects may be used to calculate a mean value or an accumulated value with reference to “A” which is randomly selected object type list information ({x|x∈A, A⊂U}) as shown in Equation 1 presented below:

$$E = \frac{1}{N} {\sum }_{i = 1}^{{N}_{A}} V ( x ) or E = {\sum }_{i = 1}^{{N}_{A}} V ( x ) \qquad Equation 1$$

The information computation module 122 may perform computation as shown in Equation 2 presented below to use all information “U” of the object type list having correct answers if the random probability (p) is greater than the first probability (P1):

$$E = \frac{1}{N} {\sum }_{i = 1}^{{N}_{U}} V ( u ) or E = {\sum }_{i = 1}^{{N}_{u}} V ( u ) \qquad Equation 2$$

Accordingly, when the object type list included in the additional information is provided, the object detection system may configure a vector (for example, information vector E) including a mean value or an accumulated value of vector information of each object corresponding to the object type list, based on the additional information.

When the additional information of the generalization intelligence model 10 is used, the information providing projection module 123 may transform the vector information (referring to information vector E) of each object type included in the additional information to merge with a result of extracting by the image feature extraction module 124, which extracts features from image information.

To achieve this, the information providing projection module 123 may be implemented by a projection multi-layer perceptron (MLP) structure, and a bias of a convolution layer provided therein may be set to a false, such that, if all of the values of input vectors are zero, all of the values of output vectors have the zero value.

That is, as shown in FIG. 7, the bias of the information providing projection module 123 is set to a false, such that, if all of the values of vector E are zero, all of the values of output E1 are zero, and in this case, the size of vector E1 has the same size as the output of the image feature extraction module 124.

The object detection system may perform a vector element-by-element sum operation on the vector information transformed by the information providing projection module 123 with respect to an output result of the image feature extraction module 124, and then, may perform object detection by applying a result of the sum operation as an input to the object detection engine.

Specifically, the vector element-by-element sum operation is performed on the output result (Fe) of the image feature extraction module 124 and the output result (E1) of the information providing projection module 123 as shown in the following equation 3, and then, the result of the sum operation may be used as an input (Fi) to the object detection engine.

$$F i = F e ⊕ E 1 \qquad Equation 3$$

That is, when only an image is provided as an input to the object detection engine, the object detection system may determine that additional information is not provided (“No”), and the information computation module 122 may output the vector “V=zeros( )” as an input, and in this case, the information providing projection module 123 may output E=zeros( ), and accordingly, even when the vector element-by-element sum operation is performed on the result of the image feature extraction module 124, the sum operation does not influence object detection.

Accordingly, when information on an object class included in the image is acquired at an object detection inference step, the information may be applied to an object detection engine inference step, so that performance is enhanced, and in addition, when additional information on objects included in the image is not provided at the object detection inference step, objection detection inference is enabled only with the given image and performance of the object detection engine is enhanced, and the object detection engine may be used in various object detection application services.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. An object detection method comprising:
acquiring, by an object detection system, image information including correct answer information on objects, and additional information on objects which is extracted through a generalization intelligence model;
training, by the object detection system, an object detection engine based on the acquired information; and
performing, by the object detection system, object detection by using the trained object detection engine,
wherein performing the object detection comprises selectively determining whether to reflect the additional information in the process of performing the object detection according to whether the additional information on the objects is acquired.

2. The object detection method of claim 1, wherein the generalization intelligence model comprises a vector information extraction module configured to apply a prompt in which an explanation on each object is written and to extract vector information from a plurality of hidden layers.

3. The object detection method of claim 2, wherein the additional information on the objects is comprised of a pair of vector information on each type of object.

4. The object detection method of claim 2, wherein performing the object detection comprises, when it is determined that the additional information on the objects is reflected, performing the object detection by reflecting the additional information including the vector information on each type of object, based on the correct answer information included in the image information, and, when the object detection is performed based on only the image information, using a zero vector to indicate the non-use of the additional information.

5. The object detection method of claim 4, wherein performing the object detection comprises using the additional information of the generalization intelligence model if a random probability (p) is less than or equal to a predetermined reference probability (p0), and using the zero vector if the random probability (p) is greater than the predetermined reference probability (p0).

6. The object detection method of claim 5, wherein performing the object detection comprises, when the additional information of the generalization intelligence model is used, using additional information on some objects if the random probability (p) is less than or equal to a first probability (P1) which is set for some objects of the entire objects included in the image information, and using additional information on the entire objects if the random probability (p) is greater than the first probability (P1), and
wherein the additional information on some objects or the additional information on the entire objects comprises a mean value or an accumulated value of vector information of each object on some objects or the entire objects.

7. The object detection method of claim 4, wherein, when an object type list included in the additional information is provided, the object detection system configures a vector comprising a mean value or an accumulated value of vector information of each object corresponding to the object type list based on the additional information.

8. The object detection method of claim 2, wherein the object detection system comprises an information providing projection module provided to transform vector information of each type of object included in the additional information to merge with an image feature extraction result when the additional information of the generalization intelligence model is used, and
wherein the information providing projection module is implemented by a projection multi-layer perceptron (MLP) structure, and a bias of a convolution layer provided in the information providing projection module is set to a false, such that, if all values of input vectors are zero, all values of output vectors are zero.

9. The object detection method of claim 8, wherein the object detection system further comprises an image feature extraction module configured to extract features from the image information, and
wherein performing the object detection comprises performing the object detection by performing a vector element-by-element sum operation on the vector information transformed through the information providing projection module with respect to an output result of the image feature extraction module, and then applying a result of the sum operation as an input to the object detection engine.

10. An object detection system comprising:
an input unit configured to acquire image information including correct answer information on objects, and additional information on objects which is extracted through a generalization intelligence model; and
a processor configured to train an object detection engine based on the acquired information, and to perform object detection by using the trained object detection engine,
wherein the processor is configured to selectively determine whether to reflect the additional information in the process of performing the object detection according to whether the additional information on the objects is acquired.

11. An object detection method comprising:
training, by an object detection system, an object detection engine based on image information including correct answer information on objects and additional information on objects which is extracted through a generalization intelligence model; and
performing, by the object detection system, object detection by using the trained object detection engine,
wherein performing the object detection comprises selectively determining whether to reflect the additional information in the process of performing the object detection according to whether the additional information on the objects is acquired.
